(19) United States
(12) Patent Application Publication
(10) Pub. No.: US 2006/0084183 A1
(43) Pub. Date: Apr. 20, 2006

(54) Method for testing the interaction between at least one liquid sample and respective solid sample

(75) Inventor: Flemming Sperling Henriksen, Foldby (DK)

Correspondence Address: SUGHRUE MION, PLLC, 2100 PENNSYLVANIA AVENUE, N.W., SUITE 800, WASHINGTON, DC, 20037, US

(73) Assignee: F. SPERLING APS, DK-8382 Hinnerup (DK)

(21) Appl. No.: 10/515,497

(22) PCT Filed: May 21, 2003
(86) PCT No.: PCT/DK03/00338

§ 371 Date: Dec. 30, 2005

(30) Foreign Application Priority Data
May 24, 2002 (DK) PA 2002 00802

(51) Int. Cl. G01N 1/00

(52) U.S. Cl. 436/174

(57) ABSTRACT

The invention relates to a method for testing the interaction between at least one liquid sample and a respective solid sample. The method comprises at least the steps of—providing adjacent first and second cavities, where said first and second cavities are in mutual communication via at least one passage, —placing the solid sample in said first cavity, —introducing the liquid sample in one of said first and second cavities, —sealing at least said first and second cavities from the exterior, so as to form a closed system of communicating cavities, —bringing said liquid sample into contact with the solid sample in said first cavity, transferring substantially all of said liquid sample to the second cavity after it has been brought into contact with the solid sample, —and testing the desired properties of any one or both of said liquid sample or said solid sample.

The present invention relates to a method for testing the interaction between at least one liquid sample and a respective solid sample.

In the field of microbiologically derived products, such as e.g. enzymes, there is a pronounced demand for test methods with a great throughput, i.e. for testing the microbiologically derived products from a lot of different microbes for a desired effect. An example of such testing could be the testing of the abovementioned enzymes for their cleaning abilities.

Presently, when testing such microbiologically derived products in the form of enzymes, the enzymes are contained in open containers. The enzymes in the containers are in a liquid phase, which may be the liquid medium in which the microbes were grown, preferably but not necessarily after the microbes have been filtered out. During the testing, a solid sample carrying a contamination suitable for the testing is gripped by appropriate means, immersed into the liquid, stirred to simulate a cleaning process, and retracted from the liquid for optical inspection.

This method has the disadvantage that the gripping means has to be cleaned after each test of a liquid sample in order to avoid contamination of the succeeding liquid sample.

The method furthermore has the disadvantage that the retracted solid sample is taken away from the liquid in the container for inspection. This entails that it is at best difficult to track and recover a liquid sample which shows the desired cleaning effect, or at worst impossible, as the open containers cannot be stored appropriately. This then complicates subsequent detailed testing of the enzyme or further growth of the microbe.

It is the object of the present invention to provide a method and a device, which overcomes the above disadvantages.

According to the present invention this problem is solved by a method according to the opening paragraph wherein said method comprises at least the steps of providing adjacent first and second cavities, where said first and second cavities are in mutual communication via at least one passage, placing the solid sample in said first cavity, introducing the liquid sample in one of said first and second cavities, sealing at least said first and second cavities from the exterior, so as to form a closed system of communicating cavities, bringing said liquid sample into contact, with the solid sample in said first cavity, transferring substantially all of said liquid sample to the second cavity after it has been brought into contact with the solid sample, and testing the desired properties of any one or both of said liquid sample or said solid sample.

By the method according to the invention the rate with which the samples can be tested is substantially increased because no separate gripping and handling means for the solid samples is needed during neither the simulation of the cleaning process nor the subsequent testing. Moreover this removes the need to clean the gripping and handling means between separate respective samples, because both the simulated cleaning process and testing can be preformed without removing the liquid and solid samples from the cavities of the closed system.

In a preferred embodiment of the method said liquid sample is repeatedly transferred between said first and second cavity, so as to enhance the interaction between said liquid sample and said solid sample.

In a further preferred embodiment of the method a plurality of closed systems of first and second cavities are provided.

Providing a plurality of closed systems is advantageous as it allows for simultaneous execution of the aforementioned steps for several liquid and solid samples.

In another preferred embodiment of the method said testing is performed without breaking the sealing of said closed system.

This is advantageous in that it is thus not necessary to have gripping and handling means for this step thereby obviating the need for any time consuming cleaning thereof. Rather, the testing may be preformed continuously as the liquid and solid samples pass by a testing station.

In a particularly preferred embodiment of the method said testing comprises optical inspection of said solid sample in said first cavity after the transfer of substantially all of said liquid sample to said second cavity.

Optical inspection is advantageous in that it is a simple way of evaluating the cleaning properties of enzymes.

In yet another preferred embodiment of the method the mutual communication between said first and said second cavity is interrupted after said transfer of substantially all of said liquid sample to said second cavity, so as to seal said first and second cavities from each other.

In this way the tested solid and in particular liquid samples may conveniently be stored in the respective cavities for further detailed testing or examination if the optical inspection indicates that the microbiologically derived product in the sample exhibits the desired properties.

In an implementation of the method liquid is transferred between said cavities by means of rollers.

This is advantageous when a large number of systems of interconnected first and second cavities are arranged side by side in a continuous web in such a manner that the at each system of first and second cavities and the passage, lie in the longitudinal direction of the web. Thereby, as the web is moved in a continuous manner, the roller will first press the liquid from the first cavity to the second when the first cavity passes the roller and subsequently press the liquid back to the first cavity when the second cavity passes the roller. Using a number of staggered rollers is in that case a convenient means for achieving that said liquid sample is repeatedly transferred between said first and second cavity as mentioned above.

In another preferred embodiment of the method the first and second cavities and the at least one passage are repeatedly manufactured as recesses in a first continuous web of flexible foil which are subsequently covered and sealed by a second continuous web of flexible foil.

By forming the first and second cavities in a continuous web, a continuous process may be achieved, where the cavities are manufactured from a foil, filled, sealed, influenced by e.g. rollers, and inspected.

Preferably said first continuous web is of a thermoplastic material. Using a thermoplastic material will allow for simple manufacture of the cavities, by a suitable process such a thermoforming. Moreover the use of a thermoplastic material is a convenient way of providing all the desired properties to the cavities, such as flexibility, transparency, liquid proof containing of the samples, etc.

Preferably, also said second continuous web of the same material as the first continuous web. This allows e.g. for easy sealing of the cavities by joining the first and second webs by welding, which is in turn advantageous in that it dogs not entail the risk of contamination of the samples with e.g. glue.

In another preferred embodiment the closed system of first and second cavities comprise at least one further cavity.

Such a configuration would, depending on the samples to be tested, be advantageous, e.g. in a system where it is necessary to apply a rinsing liquid to the solid sample after the interaction between the liquid sample and the solid sample.

The invention will now be described in greater detail by means of a non-limiting exemplary embodiment and with reference to the figures on which,

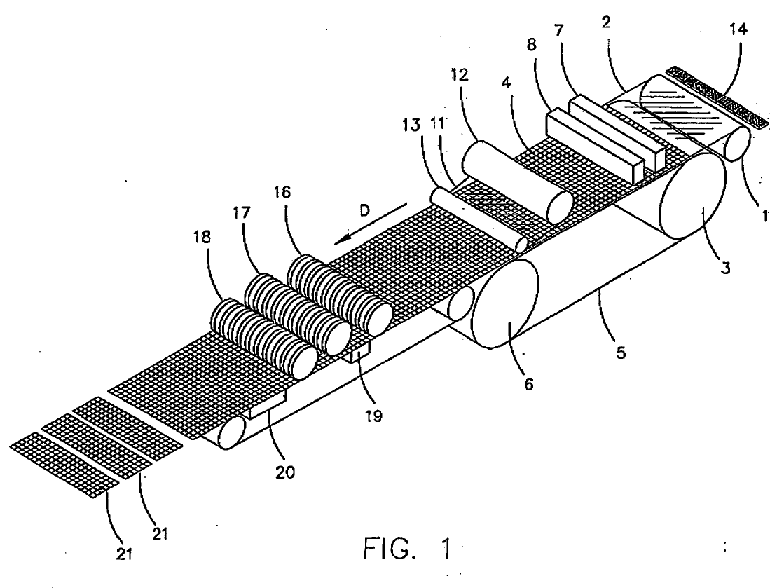

FIG. 1 is a schematic illustration of an apparatus for carrying out the method according to the invention,

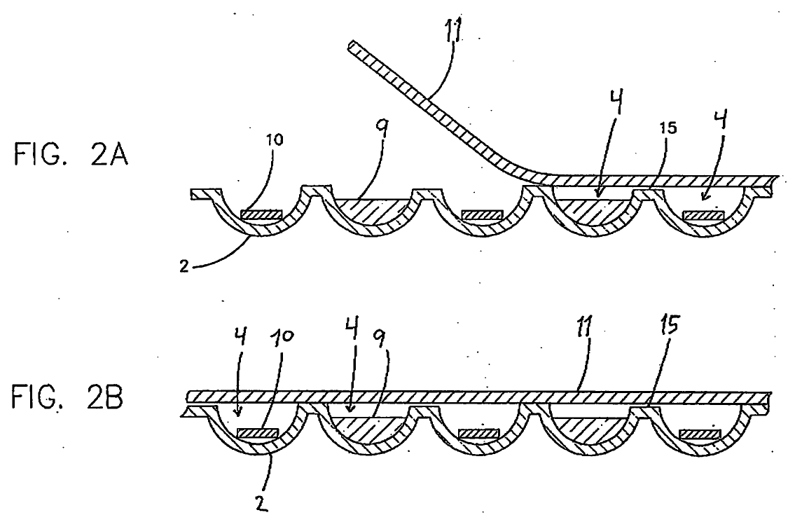

FIG. 2a is a schematic illustration of the sealing of the interconnected cavities according to one configuration of the cavities,

FIG. 2b is a schematic illustration of the sealed interconnected cavities according to an alternative configuration of the cavities,

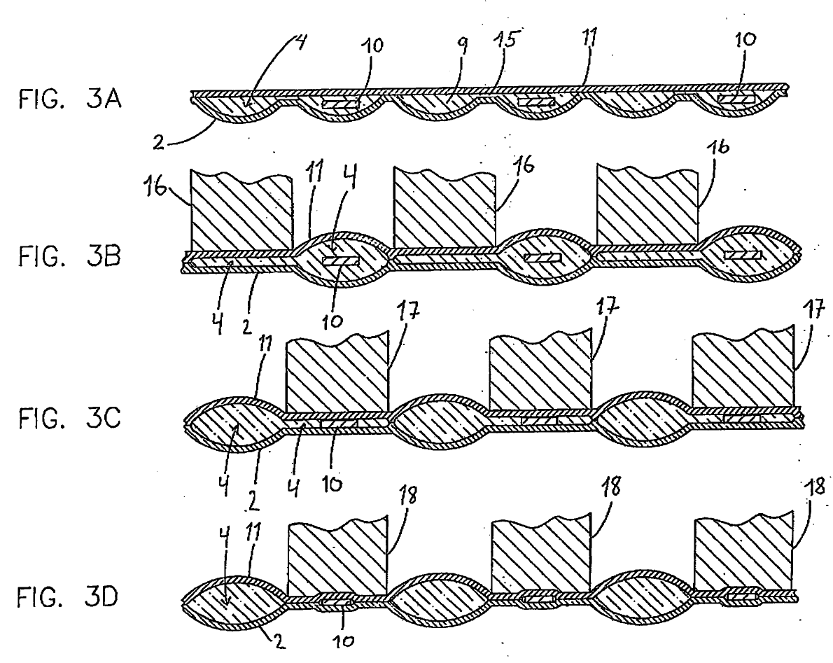

FIG. 3a to 3d are schematic drawings illustrating the interaction between the rollers and the cavities, and

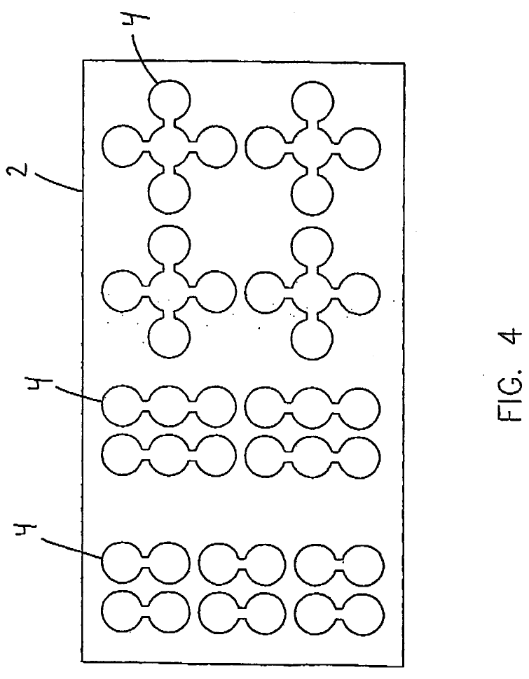

FIG. 4 is a schematic illustration of various configurations of the interconnected cavities.

In FIG. 1 is illustrated an apparatus for carrying out the method according to the invention. The apparatus is adapted for continuous operation. Reference numeral 1 depicts a roll of a web material in the form of a transparent plastic foil 2. The transparent foil 2 is unrolled from the roll 1 in the direction of the arrow D in FIG. 1 by appropriate conveyor means, which include a first roller 3. The first roller 3 not only serves as conveyor means but also for forming a number of cavities 4. These may e.g. be formed permanently by an appropriate method such as thermoforming of the transparent foil 2. Alternatively they may be formed in a temporary fashion by suction of the foil 2 into appropriate dies (not shown) in which the foil is held by sustained suction until the cavities 4 are sealed, as will be described further below. These dies may be provided in a conveyor belt 5 running around the first roller 3 and a second roller 6.

After the cavities 4 have been formed, be it permanently or temporarily, the transparent plastic, foil 2 is conveyed past a first filing station 7. At this first filling station a liquid sample 9, seen only in FIGS. 2 and 3, is introduced in some of the cavities, e.g. every other in the direction across the web as illustrated in FIG. 2b, or every other in the direction D, as illustrated in FIG. 2a. It should be noted that the drawings is schematic and that the introduction may be performed in any known manner e.g. by means of a plurality of pipettes (not shown) extracting the liquid samples 9 from an array of open containers 14. The liquid sample 9 may evidently also be introduced in all of the cavities, or be allowed to distribute itself in these as illustrated in FIG. 3a. Further, an identification marking such as a bar code identifying the liquid sample 9 may be printed on the foil in the vicinity of each filled cavity 4.

Following the first filling station 7 is a second filling station 8 past which the transparent foil 2 is conveyed. At this second filling station a solid samples 10 are introduced in some of the cavities. Preferably the solid samples 10 are introduced into the remaining cavities 4, not filled with the liquid sample. Alternatively, however, the solid samples 10 could be introduced in the same cavities as the liquid sample 8, and the remainder of the cavities 4 be left empty. It should be noted, that even though the following description and the claims refer to solid samples and the interaction of the liquid sample 9 therewith, it is to be understood that the solid samples 10 may merely act as carriers for a suitable contamination, or that the contamination is itself a solid provides on an also solid carrier. What is in either case then tested is the interaction between the liquid samples 9 and the contamination of the solid samples 10.

After the cavities 4 have been filled with liquid samples 9 and solid samples 10 in a desired fashion, the cavities 4 are sealed.

For the sealing a second transparent foil 11 is used. Instead of being transparent, this second foil 11 may be opaque or translucent having any appropriate background colour appropriate for subsequent optical inspection of the solid samples 10 and/or the liquid samples 9. It should be noticed, that if the first foil 2 and the second foil 11 are not both transparent, it is evidently of no importance whether it is the first foil 2 or the second foil 11, which has the background colour. Thus in this case the first foil 2 could instead be the opaque or translucent one with the appropriate background colour appropriate for subsequent optical inspection.

The second foil 11 is unwound from a roll 12. It is brought into contact with the first foil 2 by means of a roller 13. The sealing is preferably carried out by means of welding, because it minimises the risk of polluting the samples in the cavities 4, e.g. as compared to the risk of glue residues from gluing. Gluing is however not excluded. The welding may be any appropriate welding method, such as laser welding, ultrasonic welding, or welding by means of direct application of heat, e.g. from the roller 13. The cavities 4 are not yet individually sealed at this stage. Rather, the cavities 4 are sealed from the exterior, so as to form small systems. Within these systems passages 15 left unsealed. Such unsealed passages 15 may be provided in a plurality of different ways depending on the sealing method. If, as preferred, heat welding by means of the roller 13 is used, corresponding channels could be provided in the thermoforming die, thereby ensuring that desired parts of the first foil 2 are not brought into contact with the second foil 11 by the roller 13 during the welding.

FIG. 4 illustrates various configurations of the cavities 4 within the sealed systems. The sealed systems comprise at least two interconnected cavities 4, i.e. a first and a second cavity. As can be seen from FIG. 4, this system of a first and a second cavity sealed off from the exterior, may comprise further cavities. Such a configuration would, depending on the samples to be tested, be advantageous, e.g. in a system where it is necessary to apply a rinsing liquid to the solid sample 10 after the interaction between the liquid sample 9 and the solid sample.

After the cavities 4 have been sealed, they are passed under a number of rollers 16, 17 and 18 serving to displace the liquid sample 9 between the cavities 4. Only three rollers 16, 17 and 18 are shown in FIG. 1, but a different number of rollers may equally be used.

Each of the rollers 16, 17 and 18 have a profiled surface, with raised portions and recesses. In an alternative embodiment the rollers may be substituted by a number of spaced disks. The location of the raised portions and the recesses are staggered across the web from one roller to the next.

These rollers serve to displace the liquid sample 9 between the cavities 4 of the sealed. Systems, as will be explained below with reference to FIGS. 3a to 3d.

FIG. 3a to 3d illustrate a cross section of the cavities 4 corresponding various situations that occur along the apparatus of FIG. 1. Thus, FIG. 3a illustrate the cross section of the cavities 4, as it will appear between the sealing of the cavities 4 at roller 13 and the first roller 16 in FIG. 1.

When the web with the cavities 4 is conveyed along the apparatus, they pass under the first roller 16, as illustrated in FIG. 3b. The first roller 16 is profiled so as to have recesses and raised parts. The raised parts are arranged so as to be aligned with every other of the cavities 4 across the web. The roller 16 thus engages only some of the cavities 4. When the roller 16 engages the cavities 4 the liquid sample is pressed via the passage 15 into the neighbouring cavity 4 in which the solid sample 10 is located.

After having passed the first roller 16 the cavities 4 may, depending on the elastic properties of the first foil 2 and the second foil 11, return to the situation illustrated in FIG. 3a. Alternatively the liquid sample 9 remains in the cavity 4 together with the solid sample 10 until the cavities reach the second roller 17, as illustrated in FIG. 3c. The second roller 17 is also profiled so as to present raised parts. The raised parts are, however, staggered with respect to those of the first roller 16. Thus, when the web passes under the second roller 17 the liquid sample is pressed back into the empty cavity 4, i.e. the cavity 4 without the solid sample 10. This process may be repeated by having several sets of rollers 16 and 17 arranged in an alternating manner after each other along the apparatus of FIG. 1.

When the liquid sample 9 is: pressed back and forth between these cavities 4 it simulates a cleaning process, where the liquid sample 9, which e.g. contains enzymes, interact with the solid sample 10.

In order to enhance this interaction an optional vibration table 19 may be arranged between the rollers 16 and 17 or at any other appropriate place along the apparatus of FIG. 1.

After the liquid sample 9 and the solid sample 10 in each sealed system of cavities have been allowed to interact as much as desired, the web with the cavities 4 are passed under a last roller 18, as illustrated in FIG. 3d. This last roller 18 is also profiled to present recesses and raised parts. The raised parts are aligned with the cavities containing the solid samples 10. The raised parts of the last roller 18 press the liquid sample out of the cavity 4 containing the solid sample 10 and into the neighbouring cavity 4 of the sealed system. Preferably the last roller 18 is heated so as to weld the passage 15 shut, thereby isolating the liquid sample 9 from the solid sample 10. As can be seen from FIG. 3d, the raised parts of the roller 18 may have a shape to allow all of the liquid sample 9 to be pressed out of the cavity 4, in which the solid sample 10 is located.

After the liquid samples 9 and the solid samples have been isolated from each other, the web is conveyed past an optical inspection station 20. This optical inspection station 20 measures the properties of interest of the solid samples 10, such as reflectivity or colour, and, if desired, of the liquid samples 9.

If the optical inspection of a solid sample 10 reveals that a corresponding liquid sample 9 has the desired properties it may readily and unmistakably be identified by means of the aforementioned marking, e.g. the bar code. This is also the case even when the web is in a last step of the process cut into segments 21, adapted in size for storage and other handling.

It should be noted that the description above relates only to a preferred embodiment of the present invention, and that numerous modifications are possible within the scope of the claims. Thus, the bar code identifying the liquid samples 9 may be applied at any convenient stage, in particular in connection with the sealing of the cavities. Also the liquid samples 9 may be displaced in a direction along the web rather than across, as described above, or even both, if one of the other arrangements of the cavities illustrated in FIG. 4 is used.

1. A method for testing the interaction between at least one liquid sample and a respective solid sample said method comprising at least the steps of
providing adjacent first and second cavities, where said first and second cavities are in mutual communication via at least one passage,
placing the solid sample in said first cavity,
introducing the liquid sample in one of said first and second cavities,
sealing at least said first and second cavities from the exterior, so as to form a closed system of communicating cavities,
bringing said liquid sample into contact with the solid sample in said first cavity, transferring substantially all of said liquid sample to the second cavity after it has been brought into contact with the solid sample, and
testing the desired properties of any one or both of said liquid sample or said solid sample.

2. A method according to claim 1, wherein said liquid sample is repeatedly transferred between said first and second cavity, so as to enhance the interaction between said liquid sample and said solid sample.

3. A method according to claim 2, wherein a plurality of closed systems of first and second cavities are provided.

4. A method according to claims 1, wherein said testing is performed without breaking the sealing of said closed system

5. A method according to claim 4, wherein said testing comprises optical inspection of said solid sample in said first cavity after the transfer of substantially all of said liquid sample to said second cavity.

6. A method according to claim 1, wherein the mutual communication between said first and said second cavity is interrupted after said transfer of substantially all of said liquid sample to said second cavity, so as to seal said first and second cavities from each other.

7. A method according to claim 1, wherein said liquid is transferred between said cavities by means of rollers.

8. A method according to claim 1 wherein the first and second cavities and the at least one passage are repeatedly manufactured as recesses in a first continuous web of flexible foil which are subsequently covered and sealed by a second continuous web of flexible foil.

9. A method according to claim 8 wherein said first continuous web is of a thermoplastic material.

10. A method according to claim 9 wherein said second continuous web is of the same material as the first continuous web.

11. A method according to claim 9, wherein the first and second webs are joined by welding.

12. A method according to claim 1, wherein said closed system of first and second cavities comprise at least one further cavity.

13. A sealed system for the use in testing the interaction between at least one liquid sample and a respective solid sample,
said system comprising at least a first cavity, a second cavity a passage between said first cavity and said second cavity said solid sample and said liquid sample, and
said first cavity, said second cavity and said passage all being provided between two flexible foils sealed together around said first cavity, said second cavity and said passage so as to form a closed system of communicating cavities.

14. A sealed system according to claim 13 wherein said sealed system of cavities comprises at least one further cavity.

15. A sealed system according to any of one of claims 13 or 14, wherein said flexible foils are welded together.
